(19) United States
(12) Patent Application Publication
(10) Pub. No.: US 2006/0249246 A1
(43) Pub. Date: Nov. 9, 2006

(54) Method of fabricating replicated optics

(76) Inventors: Mark A. Ealey, Littleton, MA (US); John A. Wellman, Chelmsford, MA (US)

Correspondence Address: Iandiorio & Teska, 260 Bear Hill Road, Waltham, MA, 02451-1018, US

(21) Appl. No.: 11/124,954

(22) Filed: May 6, 2005

(51) Int. Cl. B32B 37/00

(52) U.S. Cl. 156/245; 156/247; 156/272.2

(57) ABSTRACT

A method of fabricating replicated optics includes joining a substrate to replication film on a mandrel to form an assembly; applying external energy to at least a portion of the assembly to create a moment between the replication film and the mandrel to release the replication film from the mandrel and leave it joined to the substrate.

### FIELD OF THE INVENTION

This invention relates to a method for fabricating replicated optics.

### BACKGROUND OF THE INVENTION

Current state of the art mirrors of high quality are typically made of glass, and require significant time and effort to fabricate. 1 to 2 meter aspheric mirrors, for example, take 20 and 29 months, respectively, to fabricate. For a 1 meter mirror there is required 10 months to form the blank, 5 months to grind, 3 months to polish and 2 months to coat. For a 2 meter mirror those times are 15 months, 7 months, 5 months and 2 months, respectively. These mirrors have an areal density of approximately 40 to 50 kg/m² and cost 4 million and 12 million each in single units. Even in units of 50 they cost $2.9 and $8.6 million each. And perhaps most importantly the maximum amount of these mirrors that can be fabricated in a year in the whole country is 10-20 m².

Replicated optics is one attempt to make a variety of optics including mirrors less expensively and more quickly. Replicated optic techniques usually entail forming a plastic material by e.g., coining, stamping, injection molding and then adding a proper optical coating. While this produces optical elements more inexpensively and quickly it does not always provide optical elements with the proper figure or finish. Another replication approach uses nanolaminates such as produced at Lawrence Livermore National Laboratory, see Nano-Laminates: A New Class of Materials for Aerospace Applications by Troy W. Barbee, Jr., Lawrence Livermore National Laboratory, Livermore, Calif. 94550-9234. These nanolaminates may be from one monolayer (0.2 nm) to hundreds or thousands of monolayers (200 nm) thick and are typically made from e.g. zirconium-copper, Invar, Monel-titanium. They are generally made on a mandrel whose surface has been highly finished. When the process is complete and the nanolaminate is peeled off the mandrel the revealed surface is also highly finished. However, these devices lack stiffness and so are susceptible to sag from gravity and generally are not made much larger than about 15 cm. Further, their thin shape makes them fragile and susceptible to all sorts of environmental effects including thermal, acoustic, and structural loads. Gripping it in a frame or the like to provide support risks distorting the figure of the optical element constituted by the nanolaminate.

### BRIEF SUMMARY OF THE INVENTION

It is therefore an object of this invention to provide an improved method of fabricating replicated optics.

It is a further object of this invention to provide such an improved method of fabricating replicated optics which is dramatically faster and less expensive.

It is a further object of this invention to provide such an improved method of fabricating replicated optics which provides high quality optical finishes even in the nanometer and sub-nanometer range.

It is a further object of this invention to provide such an improved method of fabricating replicated optics which results in a stiff, independent optic.

It is a further object of this invention to provide such an improved method of fabricating replicated optics which enables an order of magnitude increase in the amount of optics such as mirrors that can be produced.

It is a further object of this invention to provide such an improved method of fabricating replicated optics in which the areal density of the optic such as a mirror is reduced by approximately an order of magnitude.

The invention results from the realization that an improved less expensive more productive method for fabricating replicated optics can be effected by joining a substrate to a replication film on a mandrel to form an assembly and applying external energy, e.g. heat by temperature cycling the assembly to create a moment between the replication film and the mandrel to release the replication film from the mandrel and leave it joined to the substrate.

The subject invention, however, in other embodiments, need not achieve all these objectives and the claims hereof should not be limited to structures or methods capable of achieving these objectives.

This invention features a method of fabricating replicated optics including joining a substrate to replication film on a mandrel to form an assembly and applying an external energy source to at least a portion of the assembly to create a moment between the replication film and the mandrel to release the replication film from the mandrel and leave it joined to the substrate.

In preferred embodiments the external energy source may include ultrasonic, acoustic, heat, radiant or mechanical. This may be preceded by initialization of a critical flaw to facilitate separation. Joining may include at least one of brazing, soldering, diffusion bonding and adhesive bonding. Joining may include applying an adhesive between the substrate and the replication film, closing together the replication film and substrate, spreading the adhesive across confronting areas of the replication film and substrate and curing the adhesive to bond the replication film to the substrate to form an assembly. The substrate may include at least one of the materials silicon carbide, glass, beryllium, carbon fiber reinforced composites, and metal matrix composites. The substrate may be an active substrate or a passive substrate. The adhesive may include an adhesive medium and a particulate filler. The adhesive medium may include an epoxy material. The particulate filler may include fused silica. The adhesive may include #301-2 or 52-180-1 adhesive produced by Epoxy Technology Inc., Billerica, Mass. The temperature cycling may include an elevated temperature followed by a reduced temperature. The elevated temperature may be approximately room temperature to 50° C. and the reduced temperature may be approximately room temperature to −20° C. The elevated temperature may follow a period of room temperature. The period of room temperature may be preceded by another elevated temperature of room temperature to 50° C. The replication film may be a nanolaminate or a polymer such as Mylar, or glass film. The nanolaminate may be formed on the mandrel. The nanolaminate may include at least one of zirconium-copper, Invar and Monel-titanium. At least one of the substrate and mandrel may be subjected to temperature cycling.

The invention also features a method of fabricating replicated optics including applying an adhesive between a substrate and a nanolaminate on a mandrel, closing together the nanolaminate and substrate and spreading the adhesive across confronting areas of the nanolaminate and substrate and curing the adhesive to bond the nanolaminate to the substrate forming a bonded assembly. The bonded assembly has external energy applied to it to create a moment between the nanolaminate and the mandrel to release the nanolaminate from the mandrel and leave it bonded to the substrate.

In a preferred embodiment the external energy source may include ultrasonic, acoustic, heat, radiant or mechanical. This may be preceded by initialization of a critical flaw to facilitate separation. The substrate may be an active substrate or a passive substrate. The adhesive may include an adhesive medium and a particulate filler. The medium may include an epoxy material. The particulate filler may include fused silica. The adhesive may include #301-2 or 52-180-1 adhesive produced by Epoxy Technology Inc., Billerica, Mass. The temperature cycling may include an elevated temperature followed by a reduced temperature. The elevated temperature may be approximately room temperature to 50° C. and the reduced temperature may be approximately room temperature to −20° C. The elevated temperature may follow a period of room temperature. The period of room temperature may be preceded by another elevated temperature of room temperature to 50° C. The nanolaminate may be formed on the mandrel. The nanolaminate may include at least one of zirconium-copper, Invar and Monel-titanium.

### BRIEF DESCRIPTION OF THE DRAWINGS

Other objects, features and advantages will occur to those skilled in the art from the following description of a preferred embodiment and the accompanying drawings, in which:

FIG. 1 is a three-dimensional schematic view of a nanolaminate on a mandrel;

FIG. 2 is a three dimensional schematic view of the bottom of an active substrate;

FIG. 3 is a three dimensional schematic view of the mandrel borne nanolaminate on the table of a robot machine;

FIG. 4 is a three dimensional schematic view of the mandrel with the active substrate of FIG. 2 supported above it on the arm of the robot machine in preparation for bonding;

FIG. 5 is a three dimensional schematic view of the bonded assembly of substrate, nanolaminate and mandrel according to this invention;

FIG. 6A is a three dimensional schematic view of an active substrate bearing the nanolaminate released from the mandrel;

FIG. 6B is a three dimensional schematic view with portions broken away of a passive substrate bearing the nanolaminate released from the mandrel;

FIG. 7 is a graph of temperature vs. time from the bonding through release;

FIGS. 8-11 are schematic side elevational cross-sectional views showing the steps of applying the adhesive, squeezing out the adhesive, curing the adhesive and releasing the nanolaminate from the mandrel in accordance with this invention;

FIG. 12 is an enlarged schematic side elevational cross-sectional view of a portion of substrate-nanolaminate-mandrel assembly illustrating the adhesive;

FIGS. 13A-E are three dimensional views of a portion of a robot machine showing the substrate as controlled by the robot arm with displacement dial meters for monitoring the adhesive gap/force;

FIGS. 14-28 are three dimensional schematic views of more detailed steps in the method according to this invention;

FIG. 29 is a detailed flow diagram of the method of FIGS. 14-28.

FIG. 30 is a diagram showing a technique for enabling a microprocessor to drive the actuators to manipulate the shape of the active substrate with the nanolaminate attached;

FIG. 31 is a three dimensional diagrammatic view an active substrate usable in the method of this invention;

FIG. 32 is a three dimensional view of the other side of the active substrate of FIG. 31 showing the support structure and underside;

FIG. 33 is an enlarged three dimensional view of a portion of the support structure of FIG. 32 with actuators installed;

FIG. 34 is an enlarged three dimensional view of an actuator and actuator mounting;

FIG. 35 is an enlarged three dimensional view of another actuator and actuator mounting implementation;

FIG. 36 is a schematic, sectional block diagram of an assembly of mandrel, replication film, and substrate with an initial critical flaw being introduced;

FIG. 37 is a schematic, sectional block diagram of an assembly of mandrel, replication film, and substrate with acoustic energy being applied as the separation energy;

FIG. 38 is a schematic, sectional block diagram of an assembly of mandrel, replication film and substrate with radiation energy being applied as the separation energy; and

FIG. 39 is a schematic, sectional block diagram of an assembly of mandrel, replication film, and substrate with mechanical radiation energy being applied as the separation energy.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

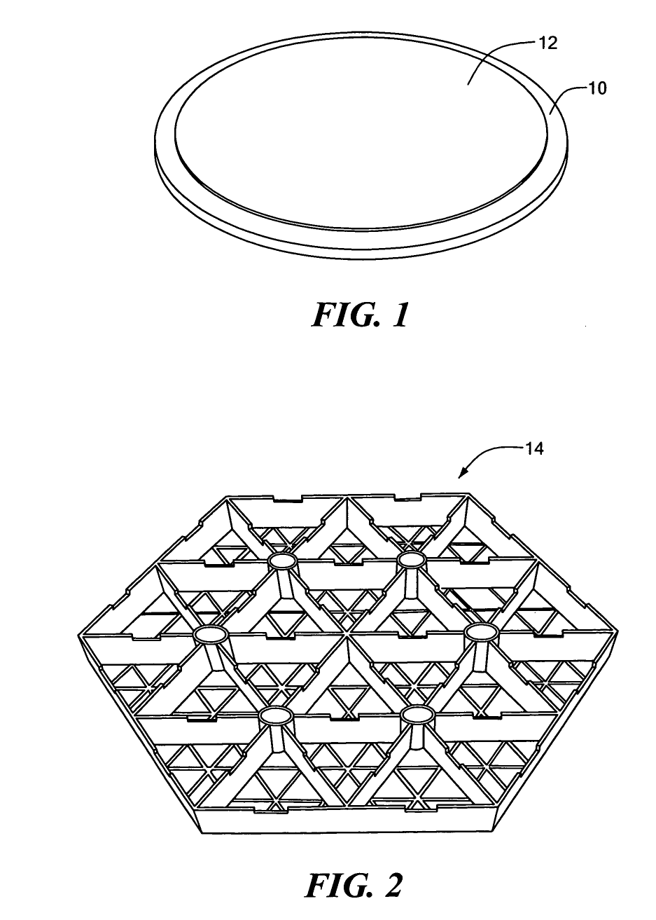

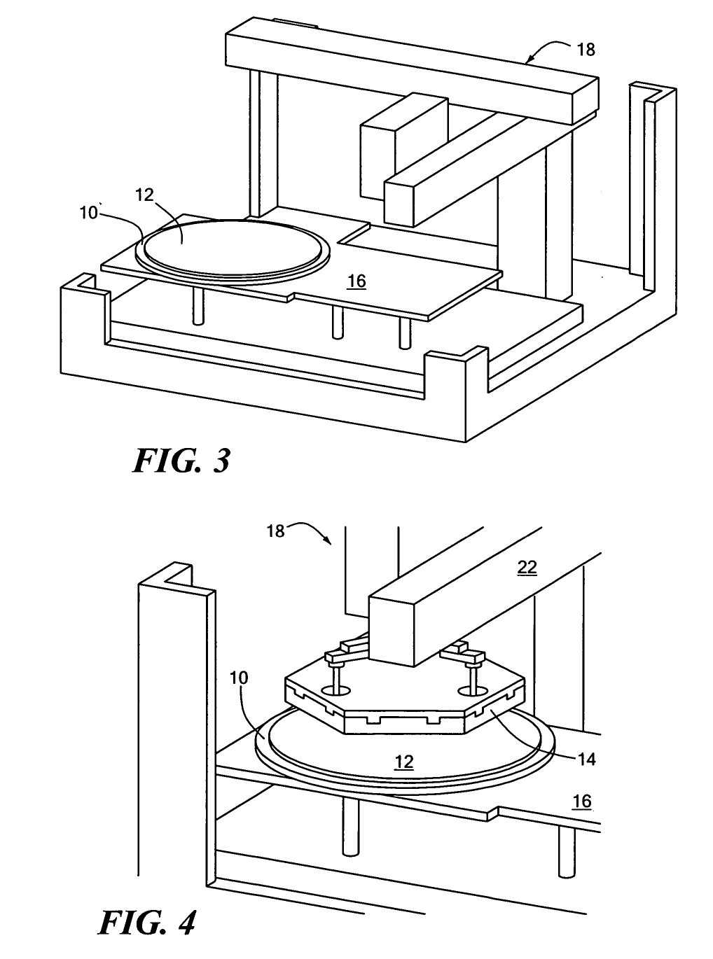

There is shown in FIG. 1 a mandrel 10 which contains on it a replication film 12 made of polymers, e.g., Mylar; ceramics e.g., silicon carbide, glass; nanolaminates e.g. zirconium-copper, Invar, Monel titanium. Nanolaminates such as used as an example in this specific embodiment may be procured from, for example, Lawrence Livermore National Laboratory. Nanolaminate 12 may be attached to mandrel 10 by means of a parting layer, such as carbon. Substrate 14, FIG. 2, which may be a passive substrate or an active one as depicted in FIG. 2, such as described in U.S. patent application Ser. No. 10/730,412, filed Dec. 8, 2003, Mark A. Ealey, entitled Integrated Zonal Meniscus Mirror, which is herein incorporated in its entirety by this reference. Mandrel 10 with nanolaminate 12 is placed on the table 16, FIG. 3, of a robot machine 18 such as an A&M Saga 5×52 positioning machine.

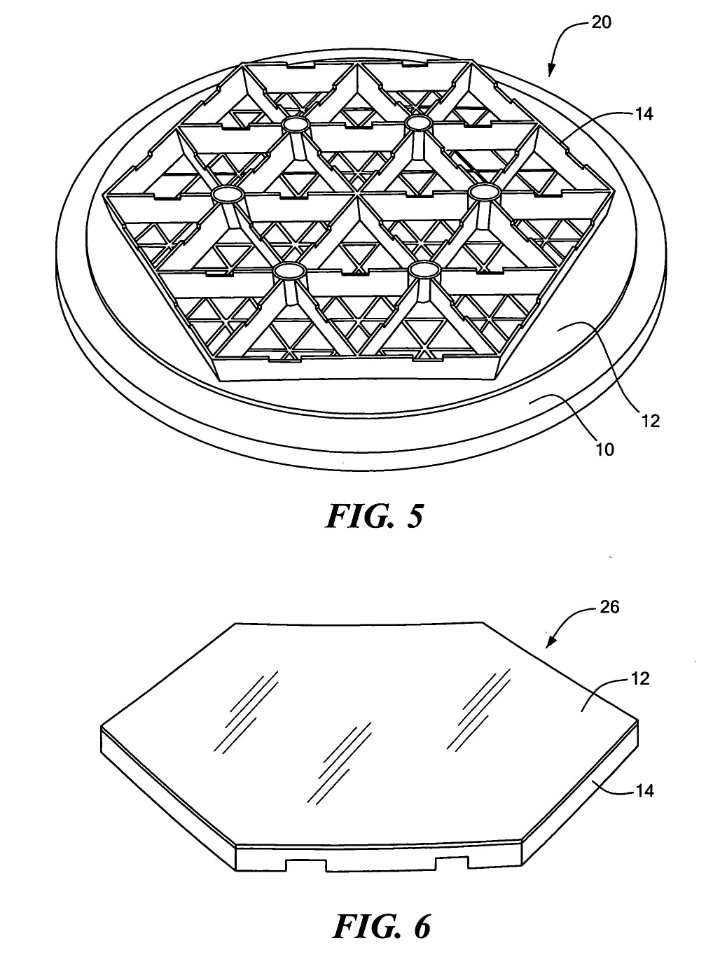

In accordance with this invention, the substrate 14, FIG. 4, is held suspended from the arm 22 of robot machine 18 over and aligned with nanolaminate 12 on mandrel 10 so that substrate 14 can be joined to nanolaminate 12. Joining can be in any suitable manner e.g. brazing, solder, diffusion bonding, other bonding including adhesives such as epoxies, phenolics, urethanes, anaerobics, acrylics, cyanoacrylates, silicones, polysulfides, elastomeric adhesives. In this illustration of a preferred embodiment an adhesive bonding effects the joining. An adhesive is placed between the confronting surfaces of substrate 14 and nanolaminate 12, then the two parts are brought together, the adhesive is distributed over the face and bonding begins. After a period of curing at room temperature, the bonded assembly 20 is put into a temperature chamber where it is cycled, FIG. 5, first to a higher temperature, typically room temperature to 50° C. to complete the curing of the adhesive, typically an epoxy such as #301-2 made by Epoxy Technology, Inc. Billerica, Mass. or a special order adhesive #52-180-1 made by Epoxy Technology, Inc. Billerica, Mass. After the curing is complete, the bonded assembly is brought down to room temperature then raised again to an elevated temperature, typically room temperature to 50° C. and then brought down to a reduced temperature typically room temperature to −20° C. This temperature cycling induces thermal moments in the bonded assembly 20 which enables the nanolaminate to separate from the mandrel on which it was introduced but remain bonded by means of the adhesive to the substrate 14. The temperature cycling to induce the thermal moments need not be of the entire assembly 20: just enough of it e.g., the mandrel 10 may be temperature cycled to induce the necessary forces to part the nanolaminate 12 from mandrel 10. The end product is a hybrid optical component, mirror 26, FIG. 6A, which includes the substrate 14 with a nanolaminate 12 adhered to it.

Substrate 14, is made typically of silicon carbide or an equivalent, such as metal, glass, ceramic, polymer and components thereof including but not limited to beryllium, carbon fiber reinforced polymer composites, metal matrix composites, Fused Silica, ULE, Zerodur, Al 6061-T6, MMC 30% SiC, Be I-70, Be I-220-H, Cu OFC, Cu Glidcop, Invar 36, Super Invar, Beryllium, Molybdenum, Silicon, SiC HP alpha, SiC CVD beta SoC RB 30% Si, C/SiC, SS 304, SS 416, SS 17-4PH, Ti 6A14V, Gr/EP GY70×30.

Although thus far and throughout the following disclosure the substrate used for mounting the replication film is an active substrate, this is not a necessary limitation of the invention only an illustrative preferred embodiment. For example, as shown in FIG. 6B, the substrate may be a stiff passive substrate 14a made of a solid material or a relieved, reinforced material. In this way, in accordance with this invention, then, the highly polished, high quality optic surface provided by the nanolaminate 12 removed from mandrel 10 provides a very high quality optic, while the substrate 14 provides the required stiffness with very little weight. In addition, since the substrate 14 can be an active substrate, such as referred to above, any deformities in the shape or figure of the mirror can be easily accommodated. Further, a number of such mirrors can be made easily and quickly using the same mandrel. That is, the mandrel finish will provide a high quality optical surface on the nanolaminate for many, many forming operations. In the neighborhood of 40 or 50 nanolaminates with high quality optical finishes can be made from a single mandrel before the mandrel has to be resurfaced. The active substrate disclosed in U.S. patent application Ser. No. 10/730,412, filed Dec. 8, 2003, Mark A. Ealey, entitled Integrated Zonal Meniscus Mirror referred to hereinabove is embodied in that description in an integrated meniscus mirror. That structure with its minutely actuatable surface segments can be used here as the active substrate even without having its surface finished as a mirror. That is, the active substrate in that disclosure can be manufactured roughly to, for example, a 25 micron mirror surface and then have a nanolaminate of perhaps 0.2 micron adhered to it to provide the desired finish and figure quality.

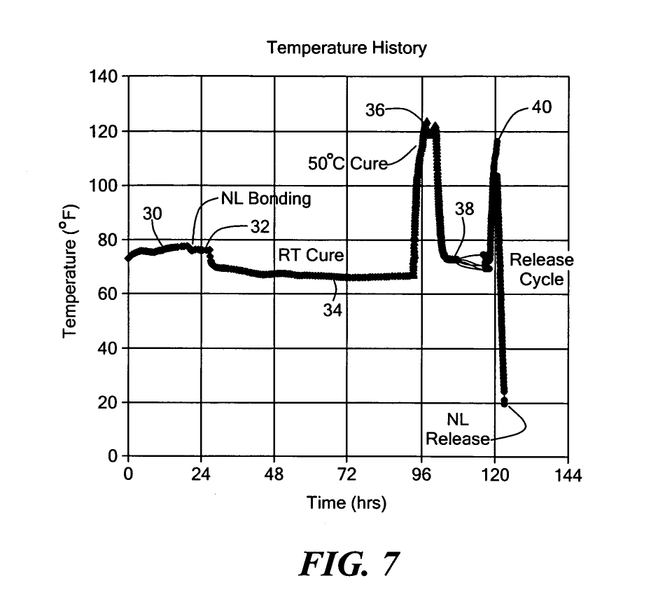

The temperature cycle of the bonded assembly 20 is depicted in FIG. 7, where it can be seen that the mandrel and nanolaminate remain generally at room temperature as shown at 30, FIG. 7, right through the initial bonding at 32. After a three day cure, 34, the temperature is raised to 50° C. or approximately 100° to 140° F. as at 36 to further cure the epoxy adhesive. The bonded assembly is then reduced to room temperature as at 38 and then less than a day later once again raised to approximately 100° to 140° F. at 40. Following this the release cycle occurs wherein the bonded assembly is reduced in temperature to somewhere between 40° and 0° F. At this point the nanolaminate releases from the mandrel due to the thermal moments induced by the temperature cycling but remains attached by the adhesive to the substrate.

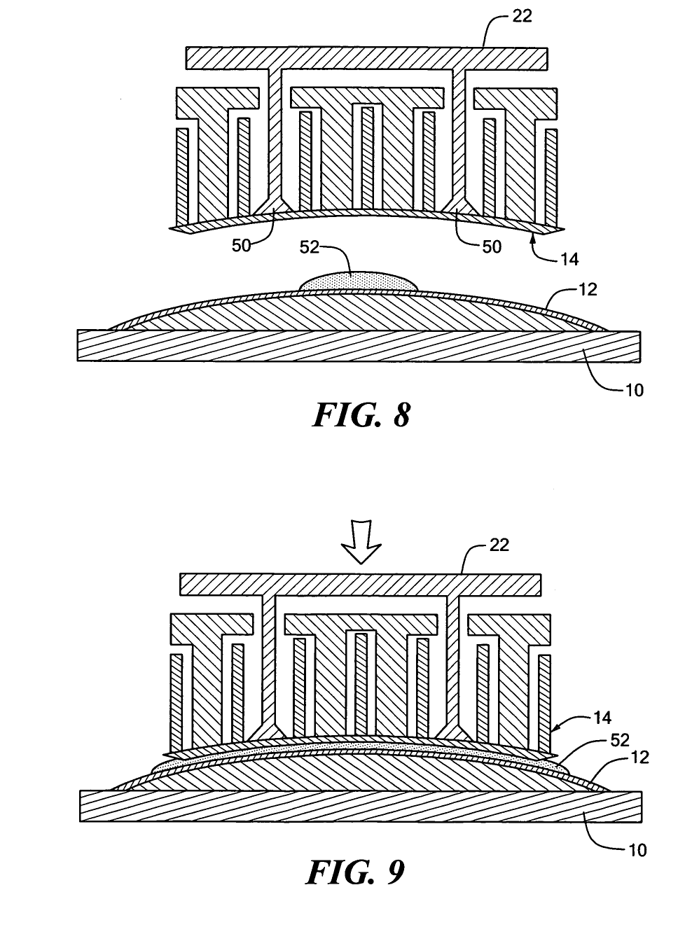

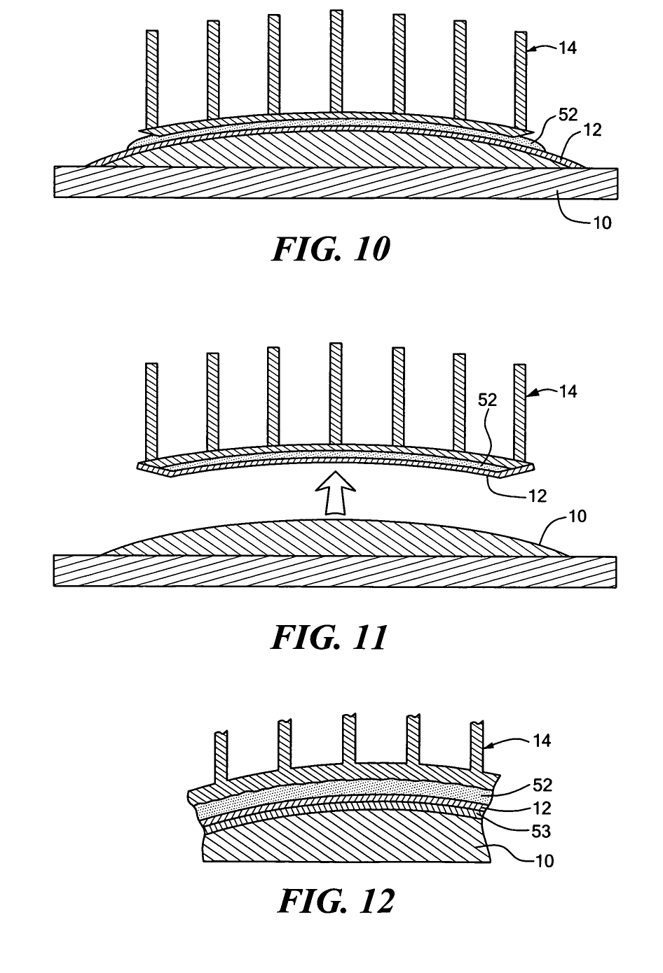

An abbreviated depiction of the steps of the method according to this invention is shown in FIGS. 8-11. Initially, FIG. 8, substrate 14 is gripped by the arm 22 of the robot machine such as for example by using holders e.g. suction cups 50. A drop of adhesive 52 is placed on top of nanolaminate 12 which is carried by mandrel 10. Arm 22 then brings down substrate 14, FIG. 9, to confront nanolaminate 12. Adhesive 52 is now spread out over both confronting surfaces. Typically the force applied is approximately 70 pounds by arm 22 and then a few more pounds, e.g., 10 to 20, will be added on manually using small weights, for example, to bring the adhesive to a uniform gap, preferably at about 2μ. When the adhesive 52 is squeezed out to a chosen uniformity the entire bonded assembly as shown in FIG. 10 is cured, first at room temperature and then at the elevated temperature. The bonded assembly is then submitted to a cycle of temperature e.g., typically an elevated temperature followed by a reduced temperature which induces thermal moments that cause the nanolaminate 12 to release from mandrel 10, FIG. 11, but remain adhered to substrate 14. Although the adhesive is explained here as being applied as a drop, that is not a necessary limitation of the invention. It could be applied by e.g., spin coating, thermal spray, double-sided tape.

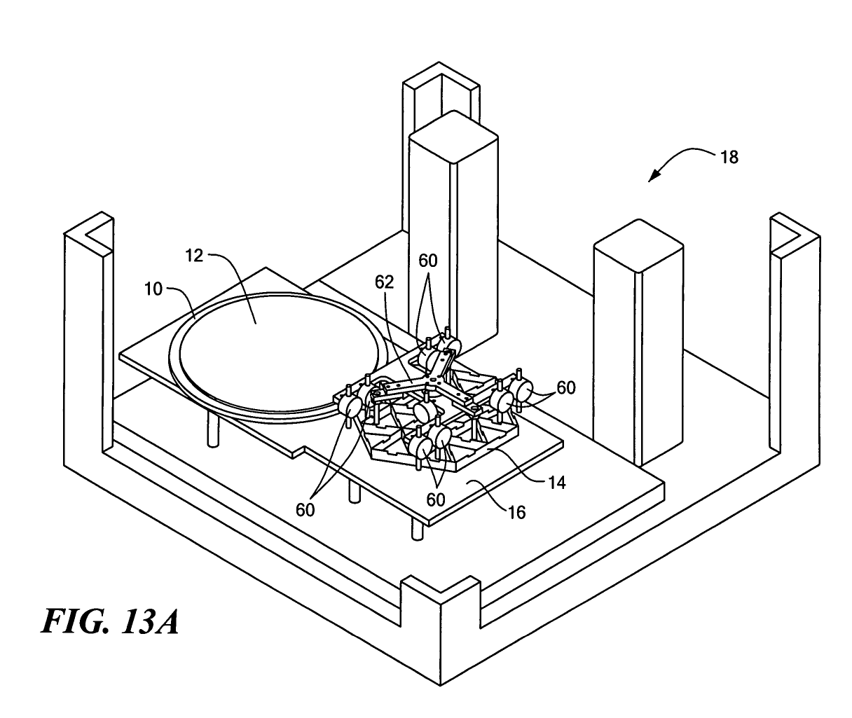

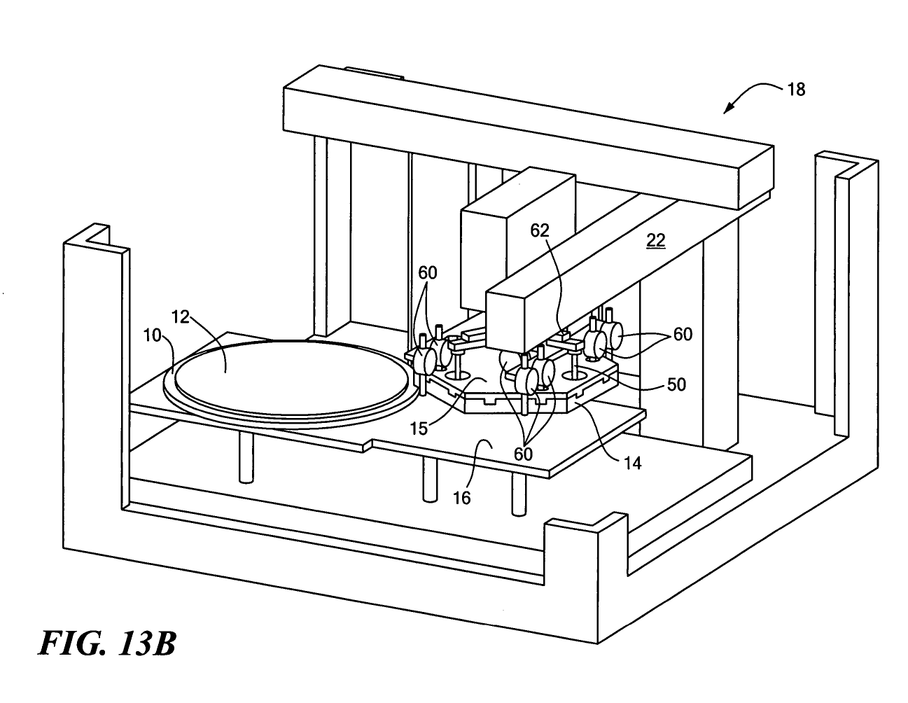

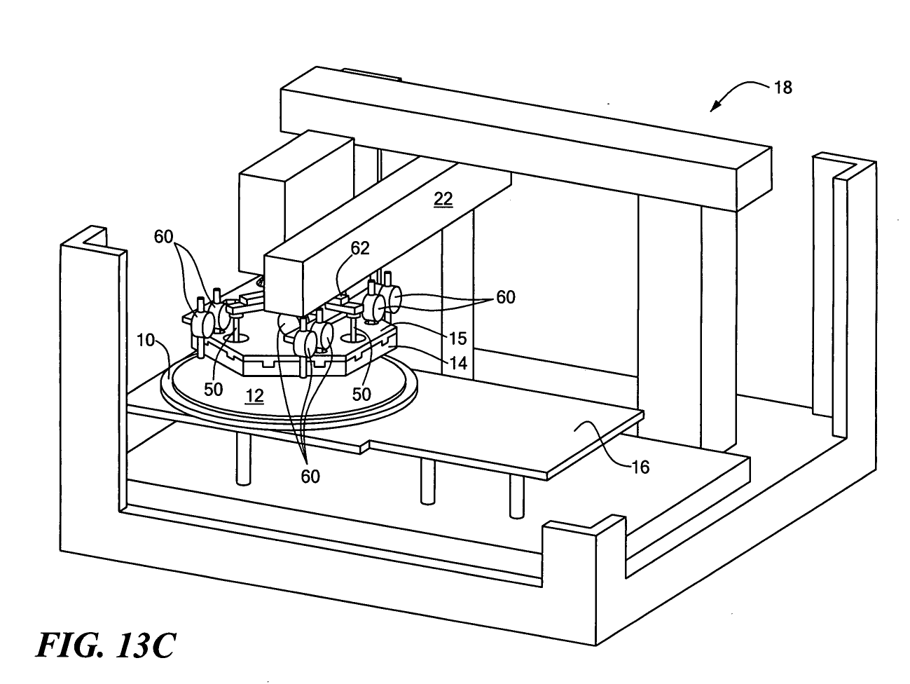

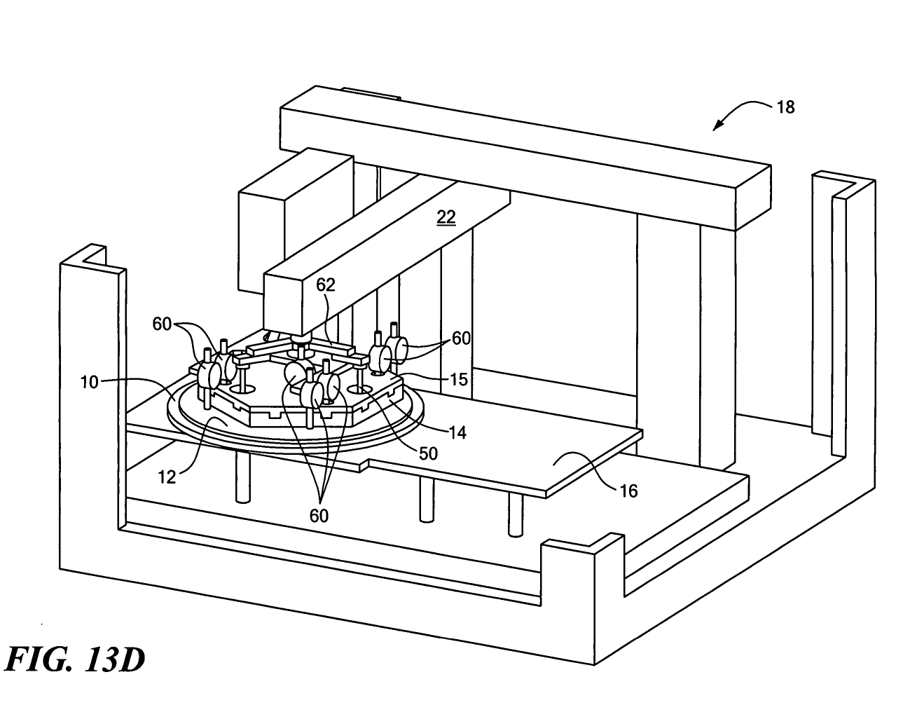

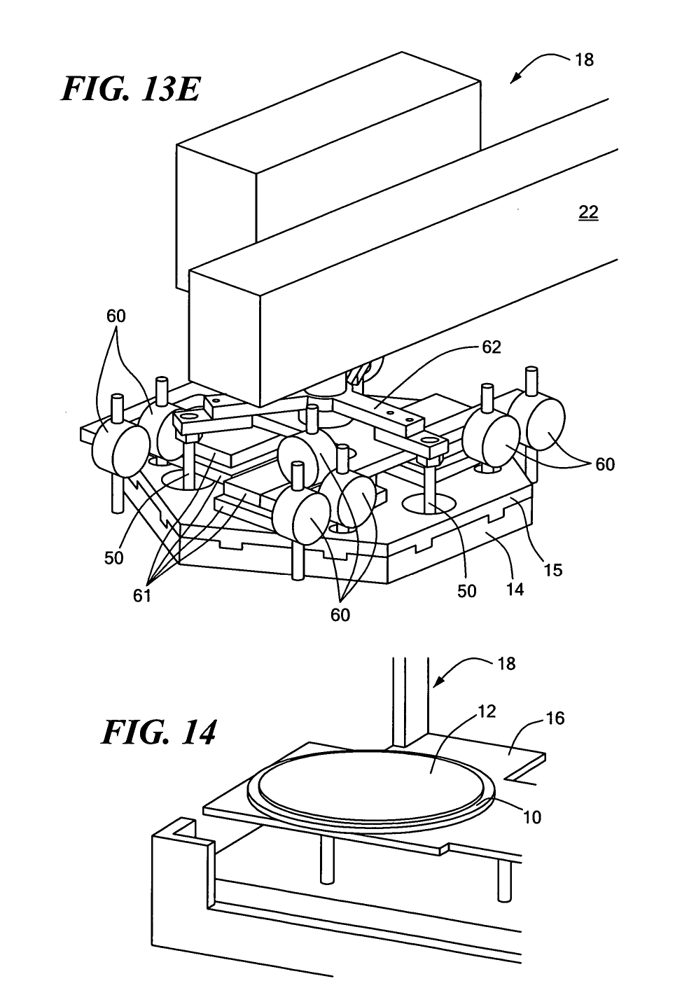

Adhesive 52, FIG. 12, performs the function of adhering nanolaminate 12 to substrate 14, but it also acts to fill and smooth the final surface of nanolaminate 12 when it is adhered to substrate 14 and released from mandrel 10. Typically substrate 12 for this method does not require a lot of final finishing. A finish, for examples, of 25μ or rougher on its surface will be sufficient: contrast this with nanolaminate 12 whose finish imbued by mandrel 10 may be in the range of 0.2 microns. Were it not for the adhesive, nanolaminate 12 would approach, to some level, the roughness of substrate 14. However, adhesive 52 not only fills the gap, but creates a mitigating medium that tends to average out the roughness associated with substrate 14 and more nearly produce the smoothness inherent in nanolaminate 12. To accomplish this adhesive 52 contains particulate material, in this preferred embodiment fused silica, in the epoxy medium. The fused silica may have a size for example of 0.8 microns for a 2 micron adhesive thickness, and the adhesive as indicated can be a #301-2 made by Epoxy Technology, Inc., Billerica, Mass. or it can be a special adhesive 52-180-1 made by Epoxy Technology, Inc., Billerica, Mass. which already has a particulate material in it. The particulate material used, whether fused silica or other, and the size of the particulate material as well as the viscosity of the epoxy as applied and the homogeneity of the mixture are all implicated in providing the smooth attachment of the nanolaminate 12 to substrate 14. Other desirable qualities of the gradient adhesive interface are that it is compliant, experiences low volume change during curing, has minimal distortion and a good matching co-efficient of thermal expansion. The combination of these things in the adhesive has only been empirically achieved and will vary depending upon the roughness of the surfaces, the type of epoxy used, the gap desired, and perhaps other parameters not yet identified. Additionally a commonly used layer, known as a parting layer, 53 is shown. This layer functions to releasably attach the nanolaminate 12 to mandrel 10. Parting layers are well known in the art. One of the materials typically used for this is carbon. The final force applied to close substrate 14 on nanolaminate 12 is guided by the use of a number of displacement dial meters 60, FIG. 13A, which may be mounted with holder 62 suspended from arm 22 not visible in FIG. 13A but visible in FIG. 13B. Arm 22, FIG. 13B, lifts substrate 14 which is shown with weighted insert 15 having holes to accommodate holders 50 and dial meters 60. Arm 22, FIG. 13C, traverses to locate substrate 14 over nanolaminate 12. Then after the adhesive is applied, arm 22 lowers, FIG. 13D, substrate 14 to nanolaminate 12. Additional weights 61, FIG. 13E, are added as indicated as necessary by dial meters 60 to produce a force on substrate 14 to result in a desired adhesive gap width and uniformity.

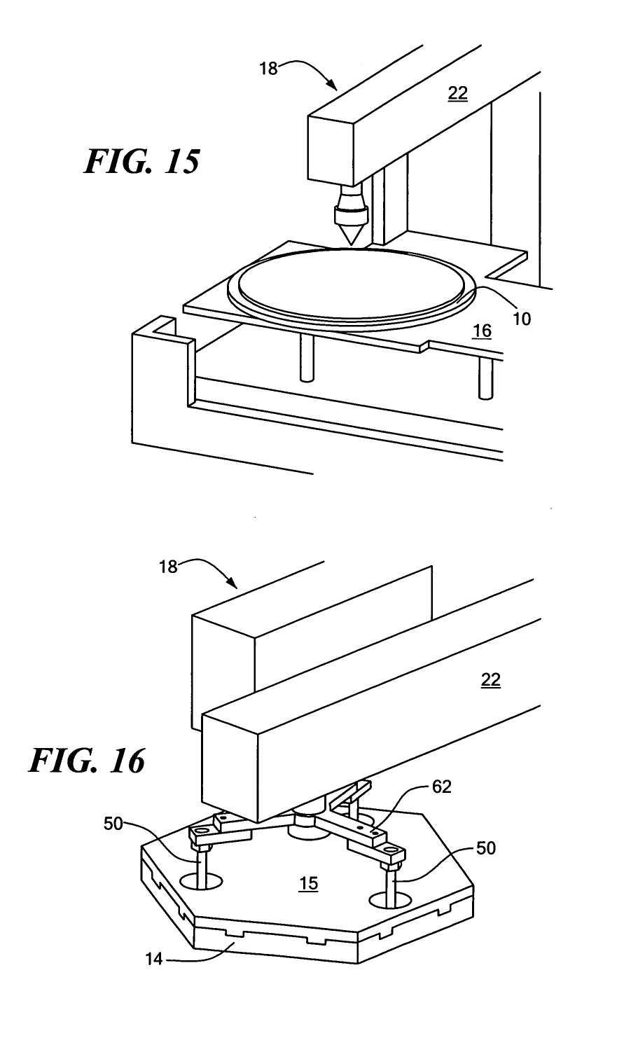

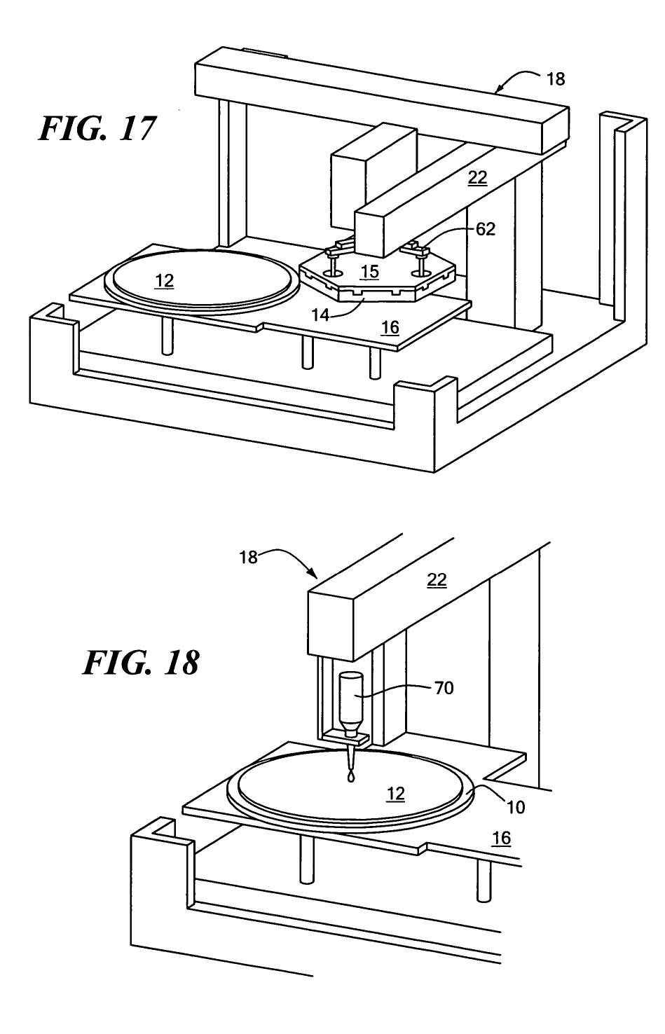

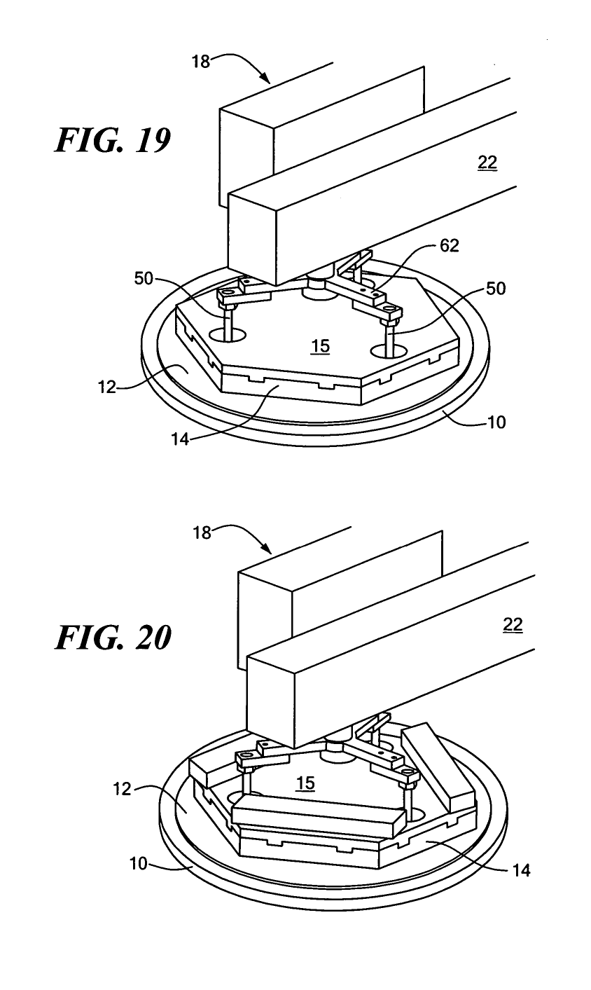

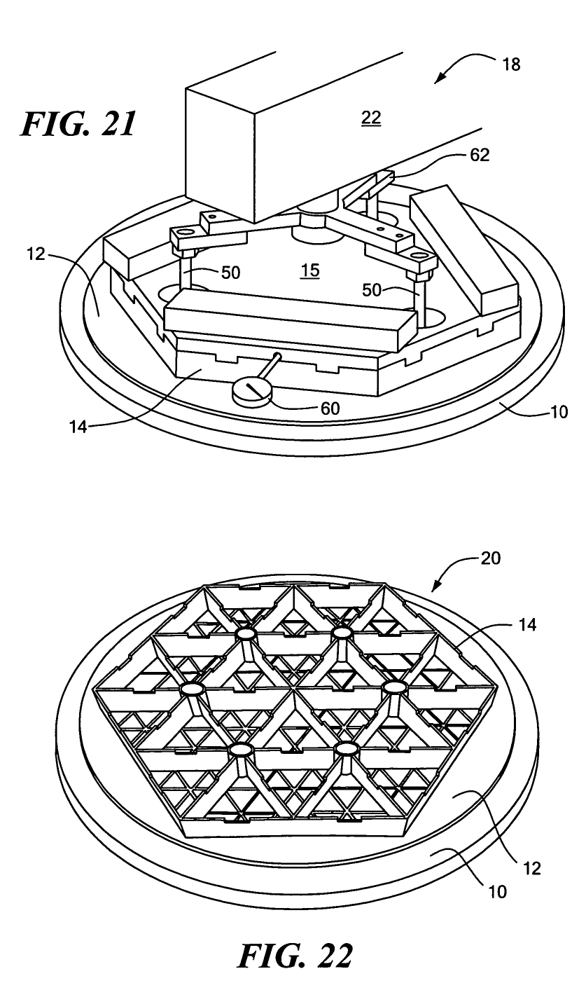

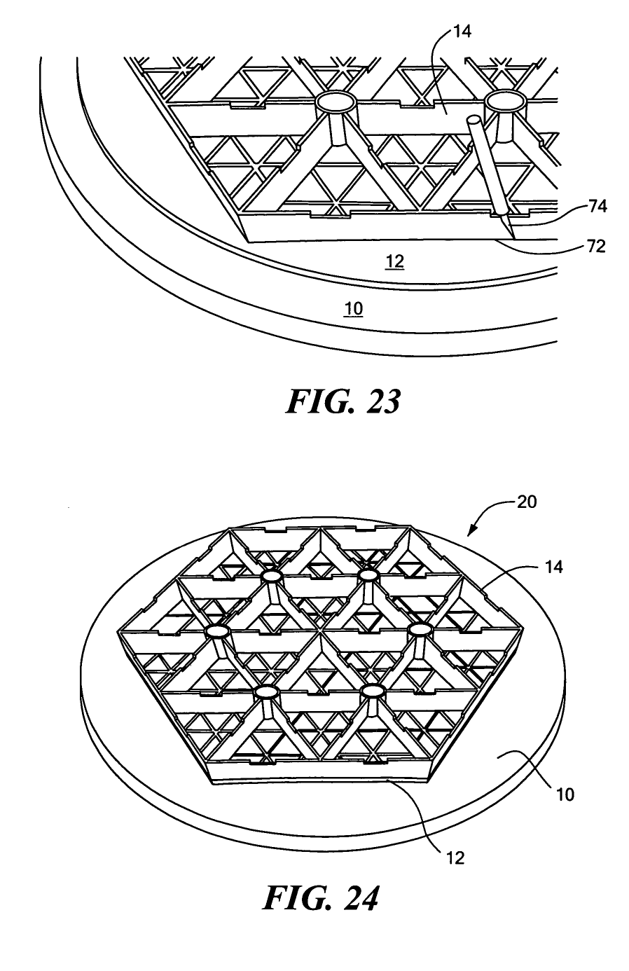

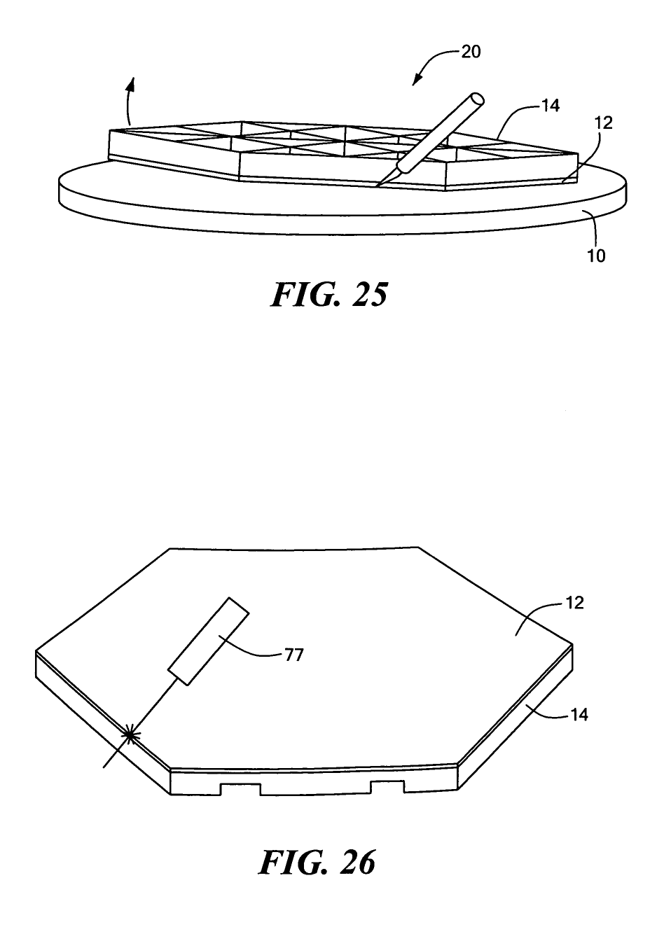

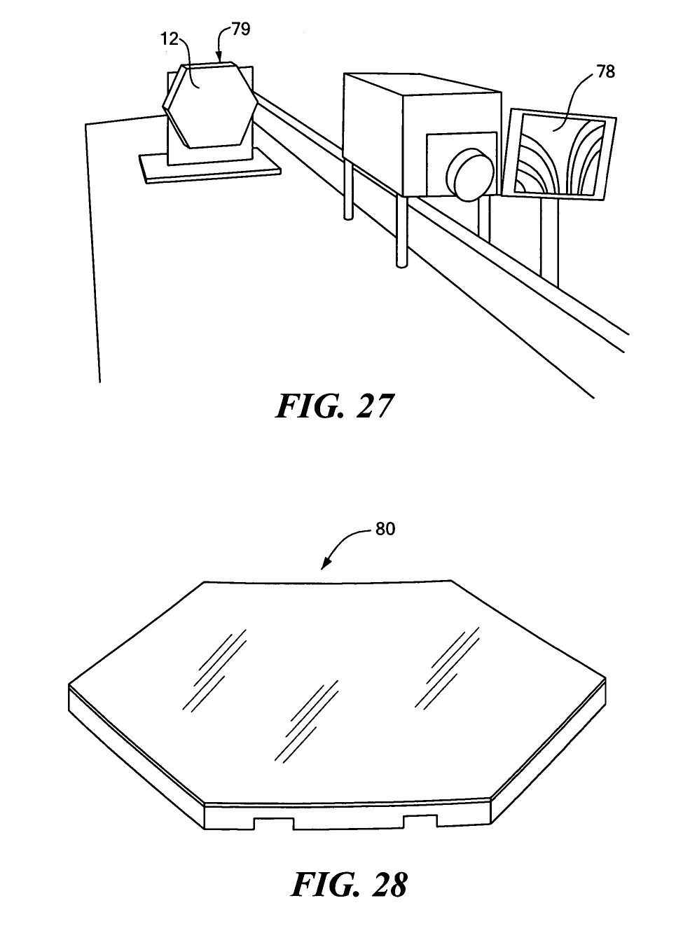

A more detailed description of the method according to this invention is shown in FIGS. 14-28. Mandrel 10 with nanolaminate 12 is installed on table 16, FIG. 14, of robot machine 18. The robot machine is then taught the position of mandrel 10, FIG. 15. Substrate 14, FIG. 16, is installed in a robot holder on arm 22 and then the robot machine 18, FIG. 17, is taught the position of substrate 14. An epoxy dispenser 70, FIG. 18, is moved over to place a quantity of adhesive on nanolaminate 12 after which substrate 14 and nanolaminate 12 on mandrel 10 are brought together. Force is then applied as previously indicated, approximately 70 pounds, FIG. 19, at first by means of arm 22 and then manually, for example, by using individual weights. This uniformity is monitored in FIG. 20 by the displacement dial meters, 60, FIG. 21, during what is known as the squeeze out period to obtain the proper gap and gap uniformity after which the adhesive, typically epoxy, is cured at room temperature, FIG. 22. Following this the excess nanolaminate 72 extending beyond the edge of substrate 14 may be trimmed off using a knife or razor blade 74, for example, FIG. 23. The bonded assembly, consisting of mandrel 10, nanolaminate 12, and substrate 14 with the adhesive between nanolaminate 12 and substrate 14, is now subjected to the temperature cycle between room temperature to 50° C. to −20° C. after which the nanolaminate is released from the mandrel, FIG. 25. The remaining excess of nanolaminate 12 may be trimmed from substrate 14, FIG. 26, using a laser knife 77. The finished optic, mirror 79 is submitted to a metrology process in which an interference pattern 78, FIG. 27, of the nanolaminate mirror surface 12 is created and fed back to adjust the individual components of the active substrate 14 to result in the ultimate light-weight, stiff, highly finished, and properly formed optic 80, FIG. 28. The actuators may be any suitable kind, such as those shown in U.S. patent application Ser. No. 10/730,514, filed Dec. 8, 2003, entitled, Transverse Electrodisplacive Actuator Array, by Mark A. Ealey and U.S. patent application Ser. No. 10/914,450, filed on Aug. 9, 2004, entitled, Improved Multi-Axis Transducer, by Ealey et al., each of them herein incorporated in its entirety by this reference.

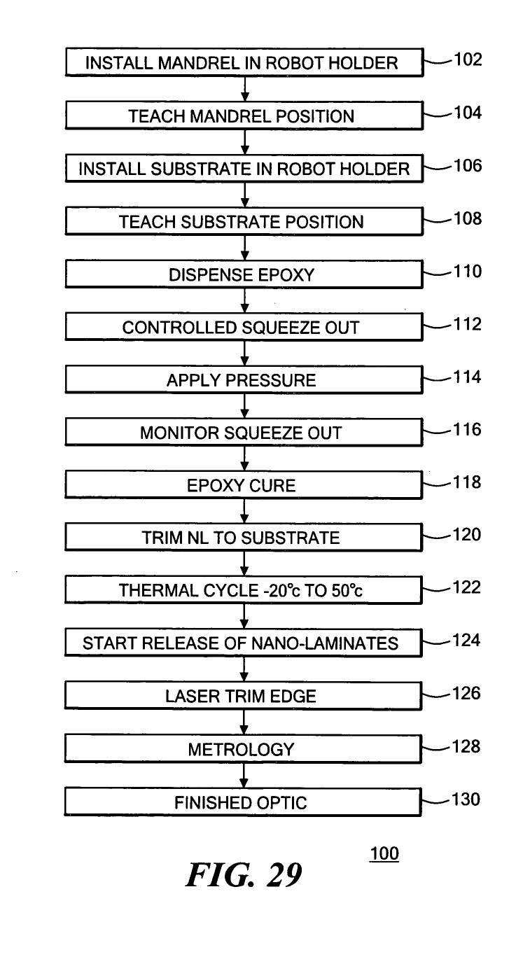

A flow chart 100, FIG. 29, of the more detailed steps of the method according to this invention depicts installing the mandrel in the robot holder 102, teaching the mandrel position 104, installing the substrate in the robot holder 106, and teaching the substrate position. The epoxy or other adhesive is then applied to the parts in step 110 and a controlled squeeze out occurs in 112. A pressure of approximately 70 pounds is applied in step 114, followed by a closer monitoring of the squeeze out. The addition of independent weights to balance and make uniform the squeeze out, if necessary, occurs in step 116. The epoxy is then cured, typically at room temperature, followed by a cure at elevated temperature. The excess nanolaminate is then trimmed to the substrate at step 120 after which the whole assembly is run through a thermal cycle between −20° C. and 50° C. in step 122. After this, further mechanical assists can be used in step 124 to start the release, although it is not always necessary. The edges are then laser trimmed in step 126, so that the nanolaminate fits neatly on the substrate. A metrology to determine any slight deformities occurs in step 128, during which a feed back of control signals can be used to offset any such deformities, after which in step 130 the finished optic is available. Although in this particular example the optic is a mirror, the invention is not limited to only that type of optic element. In accordance with this method then, by freeing the nanolaminate from the mandrel, in this way, and bonding it to a substrate there has been obtained an optical element with high strength and stiffness, low weight and a high quality optical surface finish. In addition if the substrate is an active substrate then the preparation of the substrate can be minimal as the finished product can be metered and then the proper pattern of actuation imposed on the active substrate to bring the final optical surface into complete conformity with the desired optical figure or form.

The metrology and the actual feed back and operation of the independent actuatable portions of active substrate 14 can be done in any suitable fashion, examples of this may be understood from U.S. patent application Ser. No. 10/936,229 filed on Sep. 8, 2004, entitled Adaptive Mirror System, by Mark A. Ealey and U.S. patent application Ser. No. 10/935,889 filed on Sep. 8, 2004, entitled Integrated Wavefront Correction System, by Mark A. Ealey, each of them herein incorporated in its entirety by this reference.

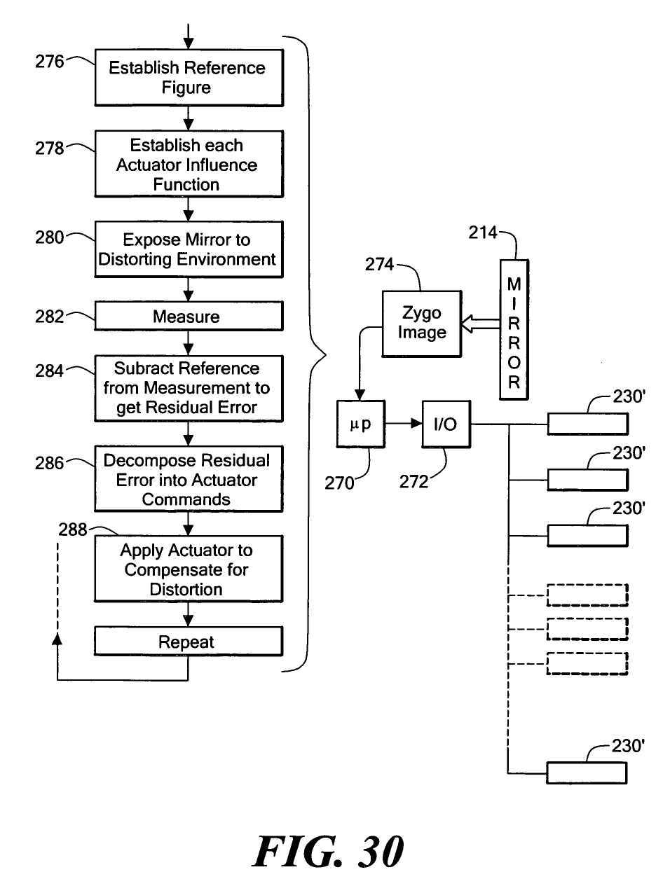

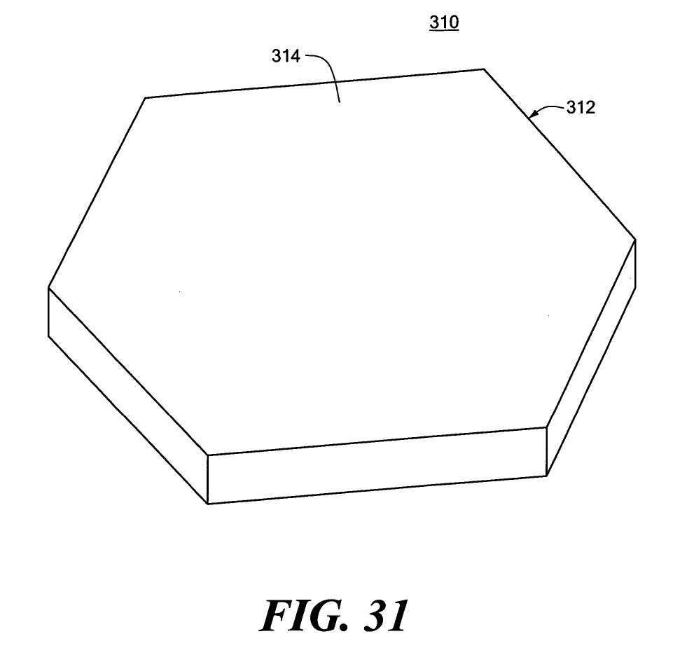

One suitable system is illustrated in FIG. 30 by way of example and not limitation. There microprocessor 270 drives I/O device 272 to provide voltages to actuators 230′. The wavefront sensor 274 such as a zygo imaging device or a Hartmann wavefront sensor, monitors mirror surface 214. Microprocessor 270 is configured with software to establish a reference FIG. 276 and then establish for each actuator an influence function on its associated nodes or zones 278. Mirror surface 214 is then exposed to a distorting environment 280 and once again measured in step 282. The reference is then subtracted from the measurement to get residual error 284 and the residual error is coded 286 into actuator commands which are then applied 288 through I/O device 272 to provide the proper voltages to actuators 230′. This routine is carried out repeatedly in order to keep the mirror at the optimum shape or figure.

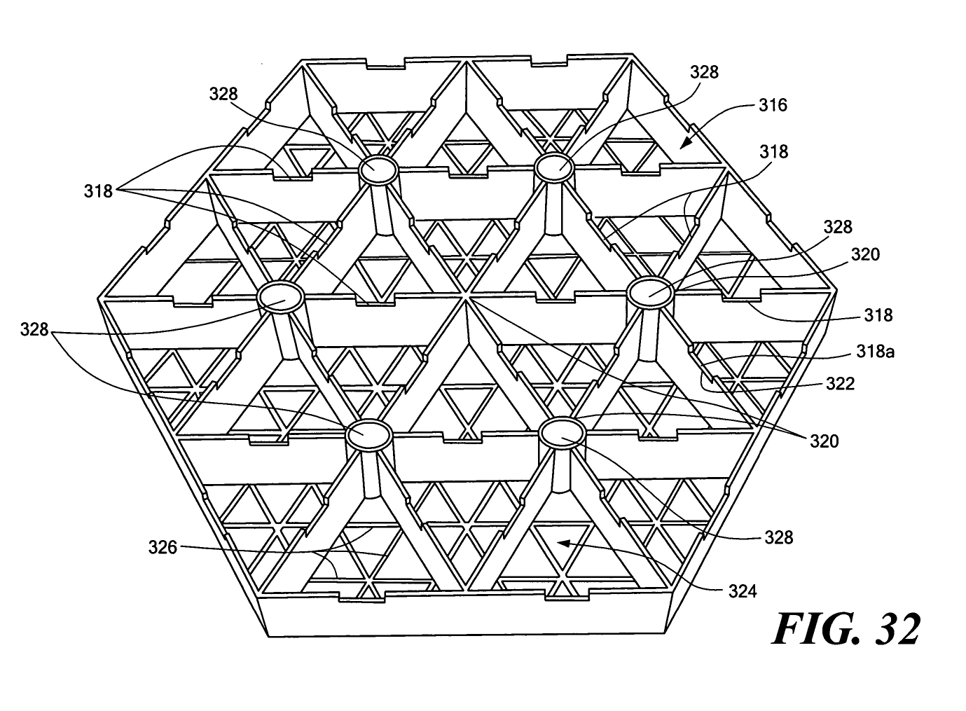

An active substrate 312, usable with this invention may include surface 314 on one side and support structure 316, FIG. 32, on the other side. The support structure may include a plurality of major ribs 318, which intersect at a node 320 at the center of a zone of influence. Each major rib, such as rib 318a, includes recess or notch 322 in which an actuator may be located. The array of major ribs creates a relieved or honeycomb-like structure supporting back side 324 of the surface 314 on which can be located cathedral ribs 326 for strengthening and further supporting mirror surface 314. The six holes 328 which coincided with particular nodes 320 are used to receive three pairs of bipods which connect to a mounting plate and form a part of the metering structure that supports the primary and secondary mirrors and additional equipment which, for example, make up a telescope or beam director.

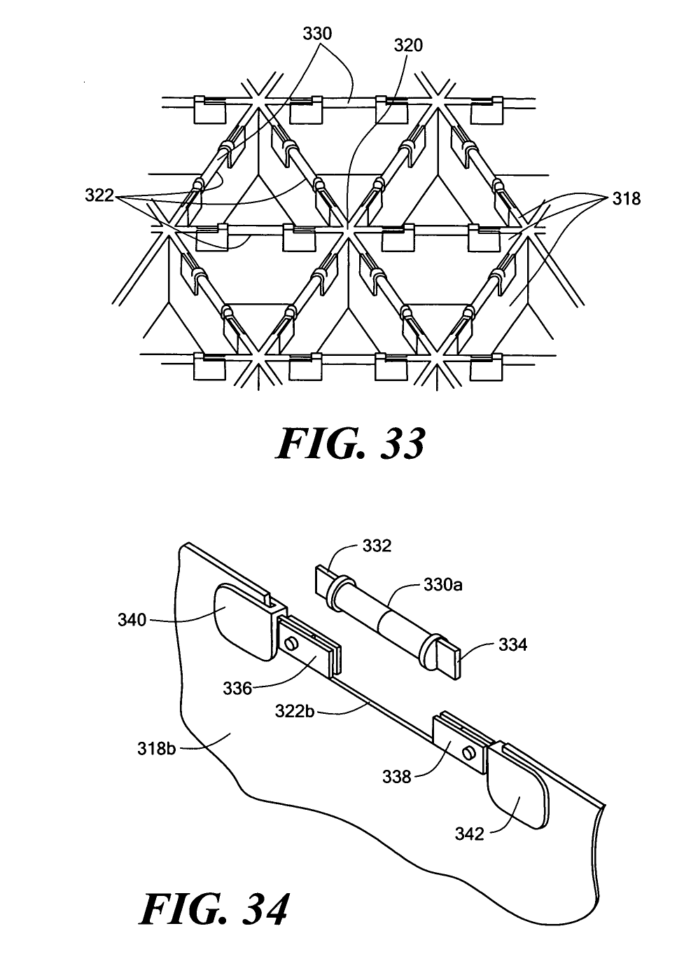

Actuators 330, FIG. 33, are embedded in recesses 322 of ribs 318 generally parallel to the surface 314 and spaced from it. When operated either by extension or contraction, actuators 330 apply bending moments to alter the shape of the surface 314 both locally for correctability, and globally to effect radius of curvature alterations. Because actuators 330 act directly on the support structure in which they are embedded, they require no reaction mass. In addition, even though they may be displacement devices, they can perform a very effective radius of curvature or excursion shape alteration because their effect is cumulative.

Each of the actuators 330 maybe an electrostrictive device, a magnetostrictive device, a piezoelectric device or any other suitable type of actuator such as hydraulic, voice coil, solenoid, mechanical or phase change material such as shape memory alloys or paraffin. In this particular embodiment, they are illustrated as electrostrictive devices of the lead-magnesium niobate or PMN type which are preferred because they have a low thermal coefficient and very little hysteresis and creep and are dimensionally stable to sub-Angstrom levels. The actuators are characteristically easy to install and replace. For example, actuator 330a, FIG. 34, may contain mounting tabs 332 and 334 which are receivable in mounting clips 336 and 338 mounted in notch 322b of rib 318b. Slots 336 and 338 may be mounted to rib 318b by means of clamps 340 and 342. All of the interfaces may be supplied with an adhesive to permanently bond actuator 330a in position. The actuators may be ambient temperature actuators or cryogenic actuators so that the mirror can be converted from one type of operation to another quite easily by simply removing one type and replacing it with the other.

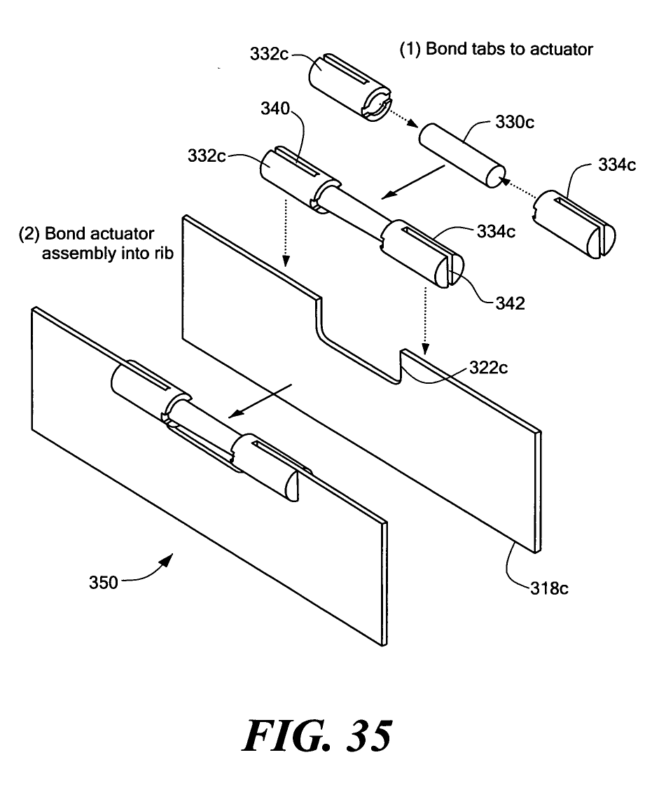

Another type of actuator mounting is shown in FIG. 35 where a three step installation is shown beginning with the actuator 330c being supplied with bonding tabs 332c and 334c which may be glued to it. This assembly is then installed in recess 322c of major rib 318c by engaging the slots 340 and 342 in tabs 332c and 334c with the edges of recess 322c so that the final assembly appears as at 350 in FIG. 35. Again, some or all of the engagements may have an adhesive applied to bond the components.

While temperature cycling is used in this preferred embodiment to separate the nanolaminate from the mandrel, this is not a limitation of the invention. Other techniques for adding energy to break that bond may as well be used. For example, the energy applied could be, e.g. mechanical, ultrasonic, acoustical, radiation as well as thermal. In addition, to aid separation a critical flaw can be initiated which will be propagated by the added energy.

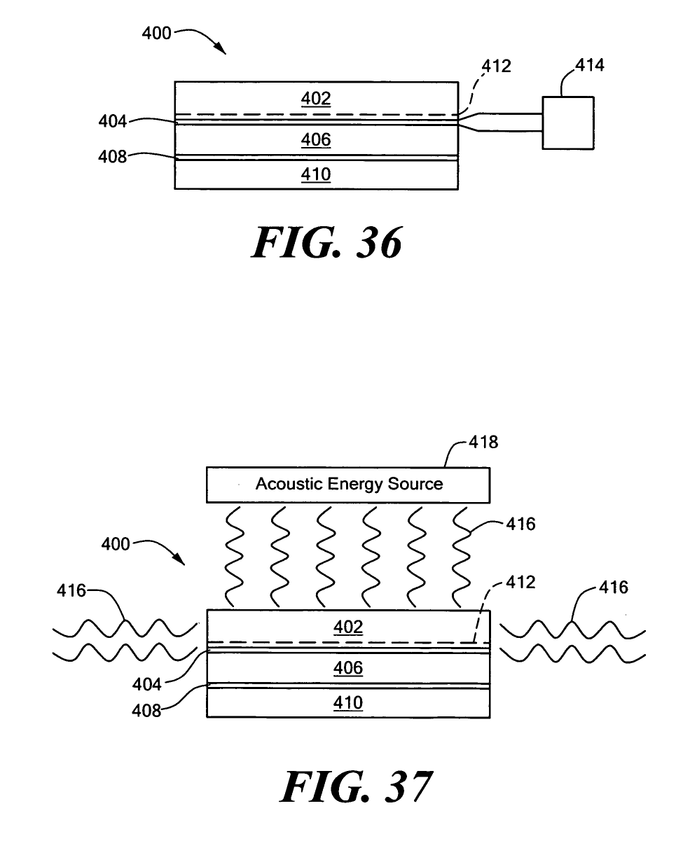

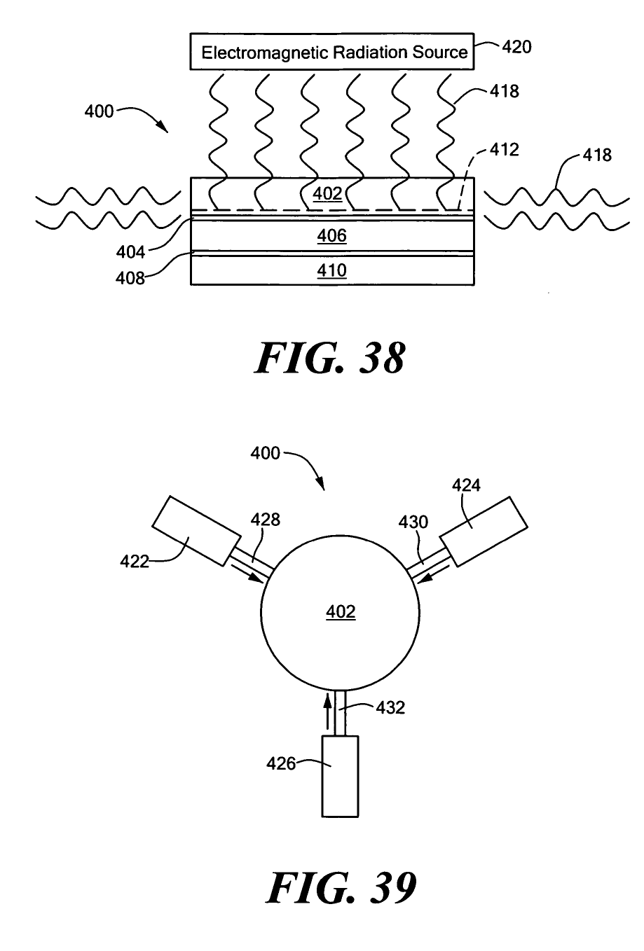

The separation begins with assembly 400, FIG. 36, including mandrel 402 joined at bond 404 to nanolaminate 406 which is in turn joined by bond 408 to substrate 410. There may also be a parting layer 412, such as carbon to facilitate separation. After initiating a critical flaw with tool 414 such as a wedge or blade at bond 404, at least a portion of assembly 400 may be subjected to external energy. Acoustic energy 416, FIG. 37, from source 418 could be applied to an end or edge of assembly 400. Or electromagnetic radiation, e.g. microwave, r.f., or light 418, FIG. 38, from a laser 420, for example, to whose light mandrel 402 is transmissive. Mechanical energy could be applied by actuators 422, 424, 426, FIG. 39, which apply rigid members or even water or gel jets 428, 430, 432.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A method of fabricating replicated optics comprising:
joining a substrate to replication film on a mandrel to form an assembly; and
applying an external energy source to at least a portion of said assembly to create a moment between said replication film and said mandrel to release said replication film from said mandrel and leave it joined to said substrate.

2. The method of claim 1 in which said external energy source applies heat energy.

3. The method of claim 1 in which said external energy source applies acoustic energy.

4. The method of claim 1 in which said external energy source applies radiant energy.

5. The method of claim 1 in which said external energy source applies mechanical energy.

6. The method of claim 1 further including initiating a critical flaw between said mandrel and replication film to facilitate separation.

7. The method of fabricating replicated optics of claim 1 in which joining includes at least one of brazing, soldering, diffusion bonding and adhesive bonding.

8. The method of fabricating replicated optics of claim 1 in which joining includes adhesive bonding.

9. The method of fabricating replicated optics of claim 8 in which joining includes applying an adhesive between said substrate and said replication film.

10. The method of fabricating replicated optics of claim 9 in which joining includes closing together the replication film and substrate and spreading the adhesive across confronting areas of the replication film and substrate.

11. The method of fabricating replicated optics of claim 10 in which joining includes curing the adhesive to bond the replication film to the substrate to form an assembly.

12. The method of fabricating replicated optics of claim 1 in which said substrate includes at least one of the materials silicon carbide, glass, beryllium, carbon fiber reinforced composites, and metal matrix composites.

13. The method of fabricating replicated optics of claim 1 in which said substrate is an active substrate.

14. The method of fabricating replicated optics of claim 2 in which said substrate is a passive substrate.

15. The method of fabricating replicated optics of claim 9 in which the adhesive includes an adhesive medium and a particulate filler.

16. The method of fabricating replicated optics of claim 15 in which said adhesive medium includes an epoxy material.

17. The method of fabricating replicated optics of claim 15 in which said particulate filler includes fused silica.

18. The method of fabricating replicated optics of claim 9 in which said adhesive includes #301-2 adhesive produced by Epoxy Technology Inc., Billerica, Mass.

19. The method of fabricating replicated optics of claim 9 in which said adhesive includes 52-180-1 adhesive produced by Epoxy Technology Inc. Billerica, Mass.

20. The method of fabricating replicated optics of claim 2 in which said heat energy is applied by temperature cycling and includes an elevated temperature followed by a reduced temperature.

21. The method of fabricating replicated optics of claim 20 in which said elevated temperature is approximately room temperature to 50° C. and said reduced temperature is approximately room temperature to −20° C.

22. The method of fabricating replicated optics of claim 20 in which said elevated temperature follows a period of room temperature.

23. The method of fabricating replicated optics of claim 22 in which said period of room temperature is preceded by another elevated temperature of room temperature to 50° C.

24. The method of fabricating replicated optics of claim 1 in which the replication film is a nanolaminate.

25. The method of fabricating replicated optics of claim 1 in which the replication film includes Mylar.

26. The method of fabricating replicated optics of claim 1 in which the replication film includes glass.

27. The method of fabricating replicated optics of claim 24 in which said nanolaminate is formed on said mandrel.

28. The method of fabricating replicated optics of claim 2 in which at least one of the substrate and mandrel are subjected to temperature cycling.

29. A method of fabricating replicated optics comprising:
applying an adhesive between a substrate and a nanolaminate on a mandrel;
closing together said nanolaminate and substrate and spreading the adhesive across confronting areas of said nanolaminate and substrate;
curing said adhesive to bond said nanolaminate to said substrate forming a bonded assembly; and
applying external energy to said bonded assembly to create a moment between said nanolaminate and said mandrel to release said nanolaminate from said mandrel and leave it bonded to said substrate.

39. The method of claim 29 in which said external energy source applies heat energy.

31. The method of claim 29 in which said external energy source applies acoustic energy.

32. The method of claim 29 in which said external energy source applies radiant energy.

33. The method of claim 29 in which said external energy source applies mechanical energy.

34. The method of claim 29 further including initiating a critical flaw between said mandrel and replication film to facilitate separation.

35. The method of fabricating replicated optics of claim 29 in which said substrate is an active substrate.

36. The method of fabricating replicated optics of claim 35 in which said substrate is a passive substrate.

37. The method of fabricating replicated optics of claim 29 in which the adhesive includes an adhesive medium and a particulate filler.

38. The method of fabricating replicated optics of claim 37 in which said medium includes an epoxy material.

39. The method of fabricating replicated optics of claim 37 in which said particulate filler includes fused silica.

40. The method of fabricating replicated optics of claim 29 in which said adhesive includes #301-2 adhesive produced by Epoxy Technology Inc., Billerica, Mass.

41. The method of fabricating replicated optics of claim 29 in which said adhesive includes 52-180-1 adhesive produced by Epoxy Technology Inc. Billerica, Mass.

42. The method of fabricating replicated optics of claim 30 in which said heat energy is applied by temperature cycling and includes an elevated temperature followed by a reduced temperature.

43. The method of fabricating replicated optics of claim 42 in which said elevated temperature is approximately room temperature to 50° C. and said reduced temperature is approximately room temperature to −20° C.

44. The method of fabricating replicated optics of claim 42 in which said elevated temperature follows a period of room temperature.

45. The method of fabricating replicated optics of claim 44 in which said period of room temperature is preceded by another elevated temperature of room temperature to 50° C.

46. The method of fabricating replicated optics of claim 29 in which said nanolaminate is formed on said mandrel.

47. A method of fabricating replicated optics comprising:
joining a substrate to replication film on a mandrel to form an assembly; and
temperature cycling at least a portion of said assembly to create a thermal moment between said replication film and said mandrel to release said replication film from said mandrel and leave it joined to said substrate.
